(19) United States
(12) Patent Application Publication
(10) Pub. No.: US 2020/0034107 A1
(43) Pub. Date: Jan. 30, 2020

(54) POLLING RATES FOR UNIVERSAL SERIAL BUS (USB) ENDPOINTS

(71) Applicant: QUALCOMM Incorporated, San Diego, CA (US)

(72) Inventors: Ameya Kulkarni, San Diego, CA (US); Jay Yu Jae Choi, San Diego, CA (US)

(21) Appl. No.: 16/519,538

(22) Filed: Jul. 23, 2019

Related U.S. Application Data
(60) Provisional application No. 62/703,108, filed on Jul. 25, 2018.

(51) Int. Cl. G06F 3/16; G06F 13/42

(52) U.S. Cl. CPC G06F 3/162; G06F 2213/0042; G06F 13/4282

(57) ABSTRACT

Systems and method for inferring polling rates for Universal Serial Bus (USB) endpoints include a driver in an audio device that measures a feedback polling interval from a host device for a plurality of periods. Based on observed periods, the audio device infers a polling period by the host device and adjusts when a feedback signal is sent to conform to the inferred polling period. By adjusting the audio device based on behavior of the operating system, the audio device may work with multiple operating systems, providing greater flexibility for an end user and also reducing the likelihood of artifacts degrading the user experience.

### PRIORITY CLAIM

The present application claims priority to U.S. Provisional Patent Application Ser. No. 62/703,108 filed on Jul. 25, 2018 and entitled “POLLING RATES FOR UNIVERSAL SERIAL BUS (USB) ENDPOINTS,” the contents of which is incorporated herein by reference in its entirety.

### BACKGROUND

### I. Field of the Disclosure

The technology of the disclosure relates generally to a Universal Serial Bus (USB) system and, more particularly, to polling rates for USB endpoints.

### II. Background

Computing devices have become common in modern society. The growth in the prevalence of computing devices has been driven in part by the continued miniaturization of components within the computing devices which has allowed the devices to evolve from cumbersome limited utility devices to small, portable, multi-function, multimedia communication and entertainment devices. Furthermore, the number and type of peripheral devices has proliferated, adding more functionality to the computing devices.

With the advent of peripheral devices, there was a need for a cable or conductor to carry signals between the computing device and the peripheral. Early cables were ribbon cables that were cumbersome and sometimes proprietary. However, commercial pressure led to consolidation into a few industry standard formats. One popular format is the Universal Serial Bus (USB) standard that defines cables, receptacles, and connectors, as well as signal formats.

While the form factor as published by the USB Implementers Forum (USB-IF) is widely used, some industry participants have created USB-compatible proprietary receptacles for their computing devices.

Regardless of the precise form factor, USB and USB-compatible cables provide great flexibility and are used for many purposes, including, but not limited to, audio devices such as microphones or speakers (or both, such as might occur in a headset). Such audio devices may include a local clock to assist in signal processing.

As most audio devices have relatively little processing power, designers have incorporated an explicit feedback mechanism through which the audio device may inform the computing device of the audio device's drift. Given enough time, that drift will introduce audio artifacts which degrade the user experience.

### SUMMARY OF THE DISCLOSURE

Aspects disclosed in the detailed description include systems and methods for inferring polling rates for Universal Serial Bus (USB) endpoints. In a particular aspect, a driver in an audio device measures a feedback polling interval from a host device for a plurality of periods. Based on observed periods, the audio device infers a polling period by the host device and adjusts when a feedback signal is sent to conform to the inferred polling period. By adjusting the audio device based on behavior of the operating system, the audio device may work with multiple operating systems, providing greater flexibility for an end user and also reducing the likelihood of artifacts degrading the user experience.

In an alternate aspect, the audio device may step through a plurality of feedback service intervals until a host operating system's polling interval is satisfied. Such stepping may be toggling between two known polling intervals or sweeping from a minimum value to a maximum value. This alternate aspect is adequate to reduce audio artifacts, but may be less flexible and have a longer settling time than the inferential aspect introduced above.

In this regard in one aspect, a device including an audio device is disclosed. The device includes a USB interface configured to be coupled to a USB-compatible cable. The device also includes a device controller including memory containing software. The device controller is configured to receive a plurality of feedback requests at a first service interval from a USB host over the USB-compatible cable. The device controller is also configured to determine that the feedback response to a first one of the plurality of feedback requests will cause a data transfer to be missed. The device controller is also configured to use a new service interval to respond to at least a second one of the plurality of feedback requests.

In another aspect, a device including an audio device is disclosed. The device includes a USB interface configured to be coupled to a USB-compatible cable. The device also includes a device controller including memory containing software. The device controller is configured to receive a first feedback request from a USB host over the USB-compatible cable. The device controller is also configured to provide a feedback response based on a first service interval. The device controller is also configured to determine that the feedback response missed the first feedback request. The device controller is also configured to switch to a second predefined service interval.

In another aspect, a method for finding a proper service interval for a USB-compatible audio device is disclosed. The method includes receiving a first feedback request from a USB host. The method also includes determining that a first feedback response transfer was missed. The method also includes receiving a second feedback request from the USB host. The method also includes using a new service interval.

### BRIEF DESCRIPTION OF THE FIGURES

FIG. 1 is a block diagram of an exemplary Universal Serial Bus (USB) system having a host and a peripheral device that infers a polling period from the host;

FIG. 2 is a flowchart illustrating an exemplary process used by the audio device of FIG. 1 to infer the polling period from the host such that the audio device may adjust provision of a feedback signal;

FIGS. 3A-3C illustrate a signal flow diagram between the host and the audio device of FIG. 1 that triggers the audio device to infer a polling period and adjust provision of a feedback signal;

FIG. 4 illustrates a computing device coupled to an audio peripheral through a USB cable; and

FIG. 5 is a block diagram of an exemplary processor-based system that can include the USB host of FIG. 1 and be coupled to a USB peripheral through a USB cable.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include systems and methods for inferring polling rates for Universal Serial Bus (USB) endpoints. In a particular aspect, a driver in an audio device measures a feedback polling interval from a host device for a plurality of periods. Based on observed periods, the audio device infers a polling period by the host device and adjusts when a feedback signal is sent to conform to the inferred polling period. By adjusting the audio device based on behavior of the operating system, the audio device may work with multiple operating systems, providing greater flexibility for an end user and also reducing the likelihood of artifacts degrading the user experience.

In an alternate aspect, the audio device may step through a plurality of feedback service intervals until a host operating system's polling interval is satisfied. Such stepping may be toggling between two known polling intervals or sweeping from a minimum value to a maximum value. This alternate aspect is adequate to reduce audio artifacts, but may be less flexible and have a longer settling time than the inferential aspect introduced above.

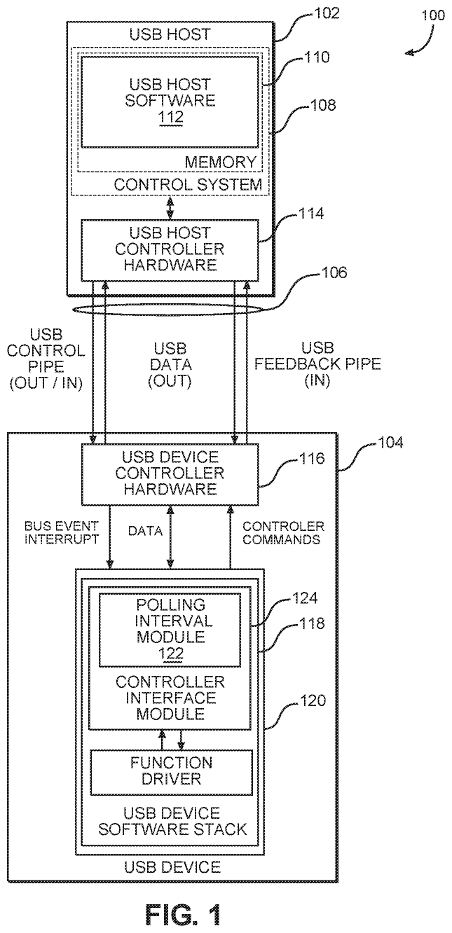

In this regard, FIG. 1 is simplified block diagram of a USB system 100 including a USB host 102 coupled to a USB peripheral device 104 through a USB cable 106. The USB host 102 may be part of a computing device such as a mobile terminal or the like. The USB host 102 may include a control system 108 that has memory 110 with USB host software 112 stored therein. The USB host software 112 operates with a USB host controller hardware 114, which may include a USB interface.

With continued reference to FIG. 1, the USB peripheral device 104 also includes a USB controller hardware circuit 116 (sometimes referred to as a peripheral USB controller hardware or device controller) that operates with a USB device software stack 118 in memory 120. The USB controller hardware circuit 116 may include a USB interface. In particular, the USB device software stack 118 includes a polling interval module 122 in a controller interface module 124 that implements aspects of the present disclosure. As illustrated, the USB controller hardware circuit 116 passes bus interrupt data to the USB device software stack 118 and receives controller commands from the USB device software stack 118. Data passes bi-directionally between the USB controller hardware circuit 116 and the USB device software stack 118.

With continued reference to FIG. 1, the USB cable 106 carries a USB control pipe signal, a data signal, and a feedback pipe signal. The USB cable 106 may be a conventional cable or may be a USB-compatible cable such as a USB cable with a LIGHTNING connector at one end. Note further that the USB cable 106 may be integrated into the USB peripheral device 104 such as when a cable is integrated into an audio headset.

While not illustrated, it should be appreciated that the USB host 102 has a system or host clock and the USB peripheral device 104 has a local clock. Only in rare, fortuitous instances are the two clocks precisely aligned and operate at precisely the same frequency. The differences may be a result of process variations, quality control, or the like. Regardless of the reason, this difference in clock frequency causes the clocks to drift relative to one another. This drift is normally addressed by providing a feedback signal to the USB host 102 from the USB peripheral device 104 and allowing the USB host 102 to adjust the pace at which packets are sent to the USB peripheral device 104.

However, there are instances when a host computing device uses an operating system that has a polling interval for the feedback signal which is not compatible with the feedback interval advertised by a USB peripheral. This situation most commonly occurs in audio speakers. Exemplary aspects of the present disclosure allow the USB peripheral to infer a polling interval used by the host computing device and adjust provision of the feedback signal in response thereto such that the feedback signal arrives in a timely fashion relative to the polling signal of the host computing device.

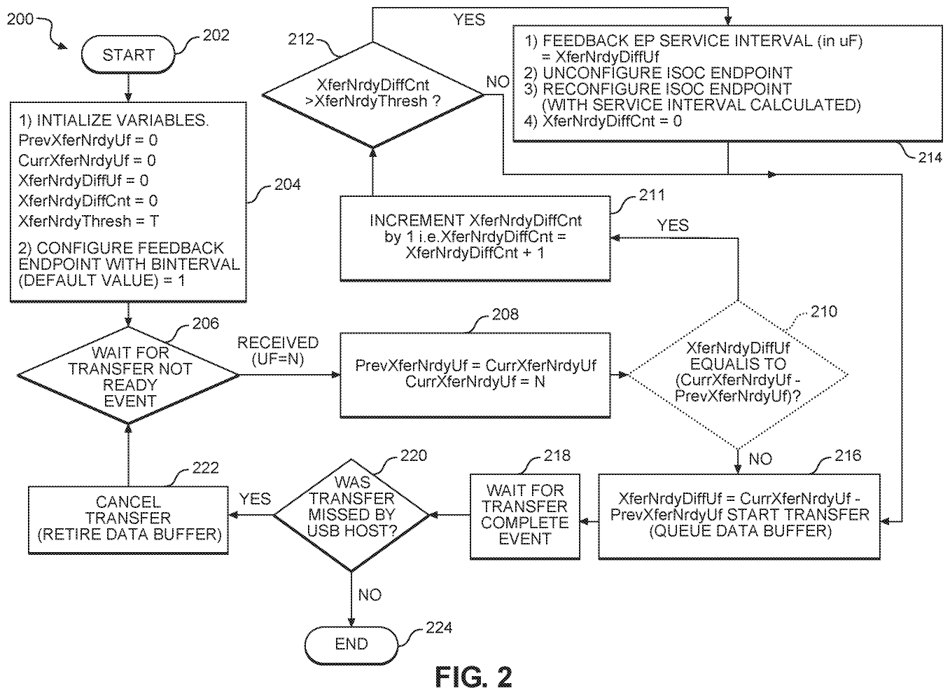

FIG. 2 provides a flowchart for a process 200 according to an exemplary aspect of the present disclosure which allows the USB peripheral device 104 of FIG. 1 to infer the polling period of the USB host 102 and adjust a feedback response. In general, a USB device controller 116 generates an event when the USB device controller 116 receives a token from a USB host 102 requesting transfer on an endpoint. When the USB device 104 does not have data buffered and the host initiates a transfer, an event is generated with the timestamp, which is referred to herein as a “transfer not ready” event. The use of “transfer not ready” in the present disclosure is chosen with the awareness that there is no standard USB device controller design and different controllers can have different names for such event without departing from the present disclosure.

In this regard, the process 200 begins at the start (block 202). The polling interval module 122 of the USB device software stack 118 initializes variables and configures the endpoint with a bInterval at a default value (block 204). The variables include PrevXferNrdyUf=0 (previous transfer not ready microframes), CurrXferNrdyUf=0 (current transfer not ready microframes), XferNrdyDiffUf=0 (transfer not ready difference microframes), XferNrdyDiffCnt=0 (transfer not ready difference count), and XferNrdyThresh=T (transfer not ready threshold). Note that there may be controller designs that do not provide a microframe number, in which case software may be used to derive a microframe number by reading a USB controller bus register on the transfer not ready or analogous bus event. Likewise the default value for bInterval may be set to 1.

The process 200 then waits for a transfer not ready event (block 206). Once the transfer not ready event has been received, the USB device software stack 118 sets PrevXferNrdyUf=CurrXferNrdyUf, and sets CurrXferNrdyUf=N, corresponding to the receipt of the transfer not ready event (block 208). The USB device software stack 118 then determines if XferNrdyDiffUf is equal to the difference of CurrXferNrdyUf and PrevXferNrdyUf (block 210). If the answer is yes, then the USB device software stack 118 increments XferNrdyDiffCnt by 1 (block 211) and compares whether XferNrdyDiffCnt is greater than XferNrdyThresh (block 212). If the answer is yes, then the USB device software stack 118 sets the feedback endpoint (EP) service interval (in microframes) equal to XferNrdyDiffUf (thus, XferNrdyDiffUf is based on the difference between the a current feedback request and a previous feedback request), unconfigures the isochronous (ISOC) endpoint, reconfigures the ISOC endpoint with the service interval just set, and updates XferNrdyDiffCnt to 0 (block 214). While the process 200 provides a specific calculation related to receipts of feedback requests, it should be appreciated that there may be other ways of evaluating time between receipt of different feedback requests to provide the same result.

If, however, the answer to block 210 is no, the answer to block 212 is no, or after block 214, the process 200 continues to set XferNrdyDiffUf=CurrXferNrdyUf-PrevXferNrdyUf and starts the transfer (queuing the data buffer) (block 216). The process 200 then waits for a transfer complete event (block 218). The USB device software stack 118 inquires whether the transfer was missed by the USB host 102 (block 220). If the answer is yes, the transfer is canceled (block 222), and the data buffer retired. If, however, the answer is no, then the process 200 ends (block 224). The process 200 is re-initiated if a feedback data transfer is missed by the host controller during a steady state. This situation may occur if the host fails to service a feedback endpoint in a timely fashion or the host dynamically changes a polling rate.

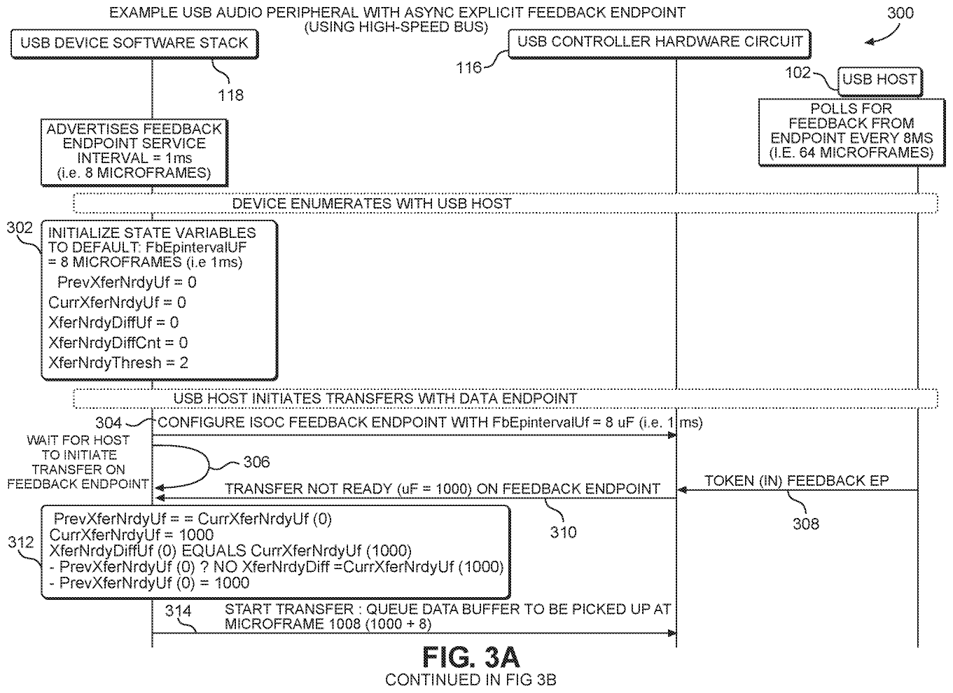

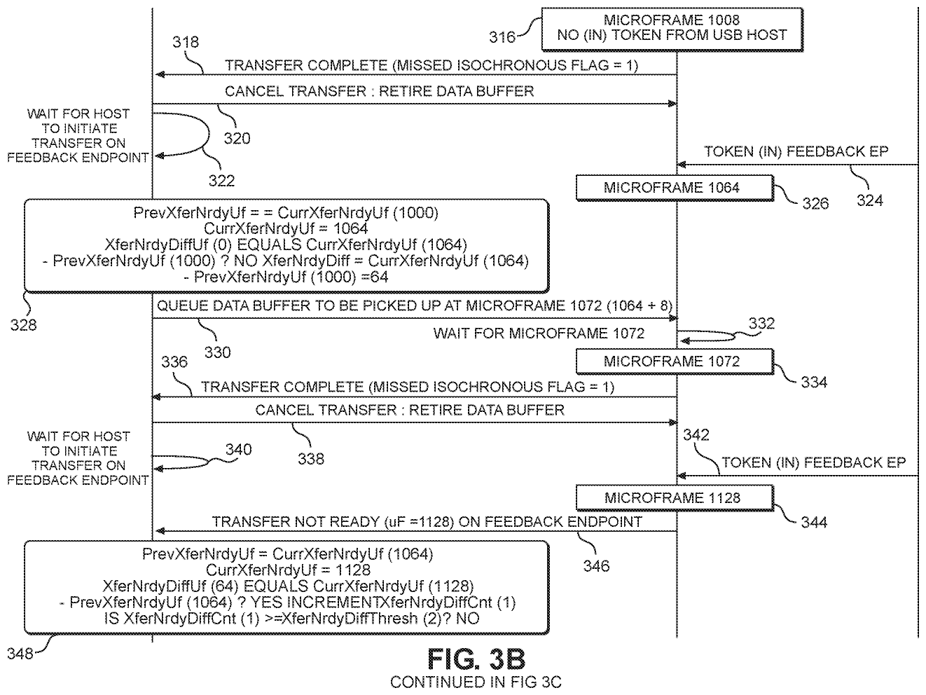

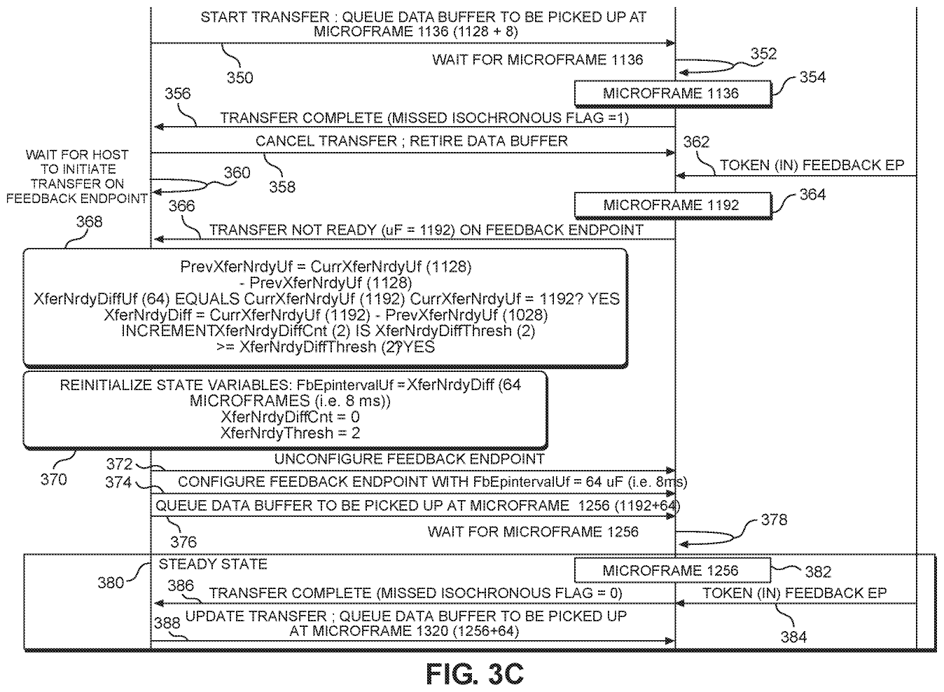

An exemplary signal flow 300 between the USB host 102 and the USB device software stack 118 corresponding to the process 200 is provided in FIGS. 3A-3C. While specific numerical values and variable names are used for the sake of the example, it should be appreciated that the process 200 may be implemented using different variable names and is able to accommodate different numerical values for the periods or other variables. The signal flow 300 starts with the USB host 102 polling for feedback from an endpoint every period (e.g., 8 milliseconds (ms) or 64 microframes). Concurrently, the USB device software stack 118 within the USB device 104 advertises a feedback endpoint service interval (e.g., 1 ms or 8 microframes). The USB host 102 may not recognize the fast endpoint service interval advertised by the endpoint within the USB device 104 and the endpoint may need to adjust provision of the feedback. After the device is enumerated with the USB host 102, the USB device software stack 118 initializes the variables (e.g., PrevXferNredyUf, CurrXferNredyUf, XferNrdyDiffUf, and XferNrdyDiffCnt) and sets the threshold to 2 (step 302). The USB host 102 initiates transfers with the data endpoint, which may be an ISOC data endpoint, in the USB device 104. The USB device software stack 118 configures the ISOC feedback endpoint with FbEpIntervalUf (feedback endpoint interval microframes)=8 microframes (e.g., 1 ms) (step 304) and waits for the USB host 102 to initiate a transfer on the feedback endpoint (step 306). At some point, the USB host 102 sends a token (in) to the feedback endpoint (step 308). The USB controller hardware circuit 116 sends a transfer not ready event (microframes=1000) on the feedback endpoint (step 310).

The USB device software stack 118 sets PrevXferNrdyUf=CurrXferNrdyUf (0) and then sets CurrXferNrdyUf=1000. The USB device software stack 118 tests if XferNrdyDiff (0)=CurrXferNrdyUf (1000)−PrevXferNrdyUf (0). The answer being no, XferNrdyDiff is set to the CurrXferNrdyUF (1000) minus the PrevXferNredyUf (0) or 1000 (step 312). The USB device software stack 118 starts the transfer and queues the data buffer to be picked up at microframe 1008 (the 1000 plus an additional microframe) (step 314).

Turning now to FIG. 3B, the USB controller hardware circuit 116 at microframe 1008 (1000, plus the 8 microframe service interval) sees no token from the USB host 102 (step 316) and signals to the USB device software stack 118 that the transfer is missed and sets the missed isochronous flag to 1 (step 318). The USB device software stack 118, seeing the missed isochronous flag, cancels the transfer and. instructs the USB controller hardware circuit 116 to retire the data buffer (step 320). The USB device software stack 118 waits for the USB host 102 to initiate a transfer on the feedback endpoint (step 322).

The USB host 102 sends a token to the feedback endpoint (step 324) at microframe 1064 (step 326). The USB controller hardware circuit 116 sends a transfer not ready event (microframes=1064) on the feedback endpoint (not shown). The USB device software stack 118 updates PrevXferNrdyUF to the value in CurrXferNrdyUf (1000) and updates CurrXferNrdyUf to 1064 (i.e., the current microframe count). The USB device software stack 118 checks whether XferNrdyDiff (0)=CurrXferNrdyUf (1064)−PrevXferNrdyUf (1000). The answer being no, XferNrdyDiff is updated to the current difference of 64 (step 328). The USB device software stack 118 sends a queue data buffer to be picked up at microframe 1072 (1064 plus the 8 microframe service interval) (step 330). The USB controller hardware circuit 116 waits for microframe 1072 (step 332), and at microframe 1072 (step 334), sends a transfer complete with the missed isochronous flag set to 1 (step 336). The USB device software stack 118, seeing the missed isochronous flag, cancels the transfer and tells the USB controller hardware circuit 116 to retire the data buffer (step 338). The USB device software stack 118 waits for the USB host 102 to initiate a transfer on the feedback endpoint (step 340).

The USB host 102 sends a token to the feedback endpoint (step 342) at microframe 1128 (step 344). The USB controller hardware circuit 116 sends a transfer not ready event at microframe 1128 on the feedback endpoint (step 346). The USB device software stack 118 updates PrevXferNrdyUf to the value in CurrXferNrdyUf (1064) and updates CurrXferNrdyUf to 1128 (i.e., the current microframe). The USB device software stack 118 checks whether XferNrdyDiff(64)=CurrXferNrdyUf(1128)−PrevXferNrdyUf(1064). The answer being yes, XferNrdyDiffCnt is incremented by 1 and XferNrdyDiffCnt is compared to XferNrdyDiffThresh to see if XferNrdyDiffCnt>=XferNrdyDiffThresh (in this case is 1>=2). The answer is no at this point (step 348).

Turning now to FIG. 3C, the USB device software stack 118 sends a queue data buffer to be picked up at microframe 1136 (1128 plus the 8 microframe service interval) (step 350). The USB controller hardware circuit 116 waits for microframe 1136 (step 352), and at microframe 1136 (step 354), sends a transfer complete event with the missed isochronous flag set to 1 (step 356). The USB device software stack 118, seeing the missed isochronous flag, cancels the transfer and tells the USB controller hardware circuit 116 to retire the data buffer (step 358). The USB device software stack 118 waits for the USB host 102 to initiate a transfer on the feedback endpoint (step 360).

The USB host 102 sends a token to the feedback endpoint (step 362) at microframe 1192 (step 364). The USB controller hardware circuit 116 sends a transfer not ready event at microframe 1192 on the feedback endpoint (step 366). The USB device software stack 118 updates PrevXferNrdyUf to the value in CurrXferNrdyUf (1128) and updates CurrXferNrdyUf to 1192. The USB device software stack 118 checks whether XferNrdyDiff (64)=CurrXferNrdyUf (1192)−PrevXferNrdyUf (1128). The answer being yes, XferNrdyDiffCnt is incremented by 1 and XferNrdyDiffCnt is compared to XferNrdyDiffThresh to see if XferNrdyDiffCnt>=XferNrdyDiffThresh (in this case is 2>=2) (step 368). The answer is yes, so the USB device software stack 118 reinitializes the state variables FbEpIntervalUf=XferNrdyDiff (64) or 8 milliseconds and XferNrdyDiffCnt=0 while XferNrdyThresh=2 (step 370). The USB device software stack 118 unconfigures the feedback endpoint (step 372) and configures the feedback endpoint using the new value of FbEpIntervalUf=64 (step 374). The USB device software stack 118 then queues the data buffer to be picked up at microframe 1256 (i.e., 1192+64) (step 376). The USB controller hardware circuit 116 waits for microframe 1256 (step 378), and at microframe 1256 (step 382), receives the token from the USB host 102 (step 384). The USB controller hardware circuit 116 sends a transfer complete event with the missed isochronous flag set to 0 (step 386). The USB device software stack 118 has entered a steady state (generally denoted at step 380) and updates the transfer queue data buffer to be picked up at microframe 1320 (i.e., 1256+64) (step 388). Note that if the USB host 102 begins polling at a different service interval in the future, this process may be repeated as needed to adapt to such new service interval dynamically.

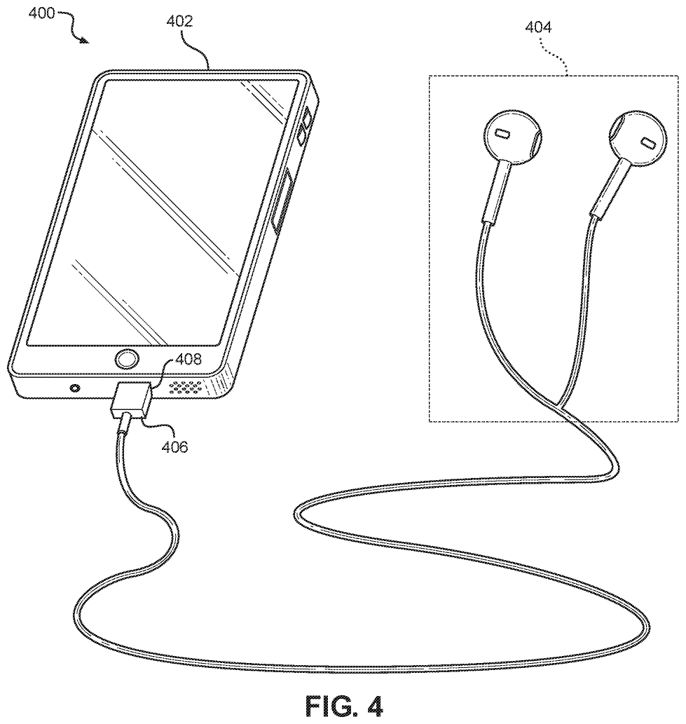

FIG. 4 provides a simplified view of a computing system 400 with a mobile terminal 402 that may include the USB host 102 of FIG. 1 and a USB peripheral 404, which may be the USB peripheral device 104. The mobile terminal 402 is coupled to the USB peripheral 404 through a USB connector 406 plugged into a USB-compatible receptacle 408.

While the above description provides one way of finding the polling interval of the host and adjusting the device to match, there are other processes which may achieve the same result. For example, instead of listening for polling from the host and calculating a polling rate based thereon, the device may, instead, sweep between a low and high value (e.g. 0.5 ms to 10 ms) until a positive response is generated from the host signifying that the host has received the feedback signal. The sweeping may be performed with incremental steps such that intermediate service intervals between the two extremes (e.g., 0.5 ms and 10 ms) are tested. As another example, the device may toggle between the two (or more) most common polling frequencies or service intervals (e.g., 1 ms and 8 ms) to determine which one is being used by the host. That is, the device may toggle between different ones of a defined set of a plurality of possible service intervals. If there are only two service intervals (e.g., 1 ms and 8 ms), then the device toggles between the set of two service intervals. If more service intervals are commonly used, the set may include them as well, but the device tests only those intervals which are defined in the set.

The systems and methods for inferring polling rates for Universal Serial Bus (USB) endpoints according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

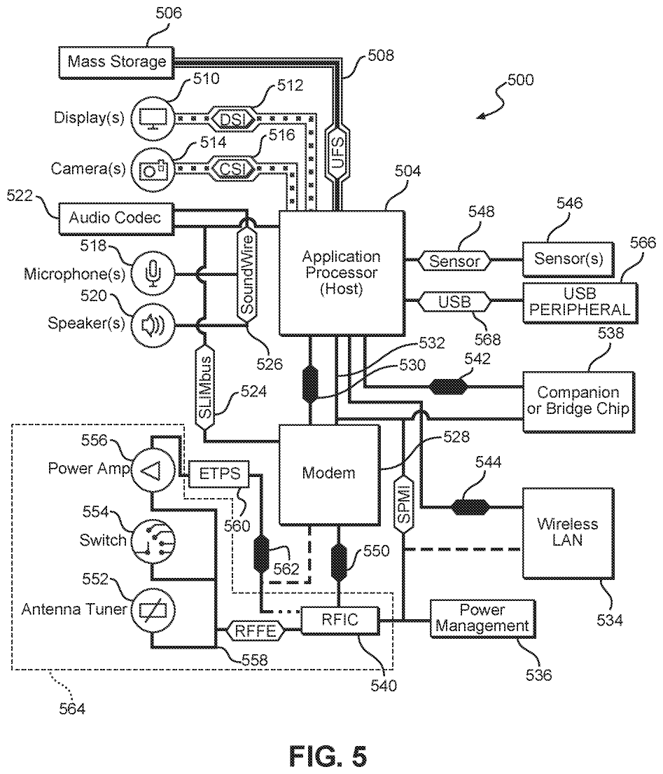

In this regard, FIG. 5 is a system-level block diagram of an exemplary mobile terminal 500 such as a smart phone, mobile computing device tablet, or the like. While a mobile terminal having a USB bus is particularly contemplated as being capable of benefiting from exemplary aspects of the present disclosure, it should be appreciated that the present disclosure is not so limited.

With continued reference to FIG. 5, the mobile terminal 500 includes an application processor 504 (sometimes referred to as a host) that communicates with a mass storage element 506 through a universal flash storage (UFS) bus 508. The application processor 504 may further be connected to a display 510 through a display serial interface (DSI) bus 512 and a camera 514 through a camera serial interface (CSI) bus 516. Various audio elements such as a microphone 518, a speaker 520, and an audio codec 522 may be coupled to the application processor 504 through a serial low-power interchip multimedia bus (SLIMbus) 524. Additionally, the audio elements may communicate with each other through a SOUNDWIRE bus 526. A modem 528 may also be coupled to the SLIMbus 524 and/or the SOUNDWIRE bus 526. The modem 528 may further be connected to the application processor 504 through a peripheral component interconnect (PCI) or PCI express (PCIe) bus 530 and/or a system power management interface (SPMI) bus 532.

With continued reference to FIG. 5, the SPMI bus 532 may also be coupled to a local area network (LAN or WLAN) IC (LAN IC or WLAN IC) 534, a power management integrated circuit (PMIC) 536, a companion IC (sometimes referred to as a bridge chip) 538, and a radio frequency IC (RFIC) 540. It should be appreciated that separate PCI buses 542 and 544 may also couple the application processor 504 to the companion IC 538 and the WLAN IC 534. The application processor 504 may further be connected to sensors 546 through a sensor bus 548. The modem 528 and the RFIC 540 may communicate using a bus 550.

With continued reference to FIG. 5, the RFIC 540 may couple to one or more RFFE elements, such as an antenna tuner 552, a switch 554, and a power amplifier 556 through a radio frequency front end (RFFE) bus 558. Additionally, the RFIC 540 may couple to an envelope tracking power supply (ETPS) 560 through a bus 562, and the ETPS 560 may communicate with the power amplifier 556. Collectively, the RFFE elements, including the RFIC 540, may be considered an RFFE system 564. It should be appreciated that the RFFE bus 558 may be formed from a clock line and a data line (not illustrated).

Relevant to the present disclosure, the application processor 504 may be coupled to a peripheral device 566 through a USB cable 568. The application processor 504 may be the USB host 102 of FIG. 1 and the peripheral device 566 may be the USB peripheral device 104 of FIG. 1.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the genetic principles defined herein may be applied to other variations. Thus, the disclosure is not intended to be limited to the examples and designs described herein, but is to be accorded the widest scope consistent with the principles and novel features disclosed herein.

What is claimed is:

1. A device comprising an audio device comprising:
a Universal Serial Bus (USB) interface configured to be coupled to a USB-compatible cable; and
a device controller comprising memory containing software configured to:
receive a plurality of feedback requests at a first service interval from a USB host over the USB-compatible cable;
determine that a feedback response to a first one of the plurality of feedback requests will cause a data transfer to be missed; and
use a new service interval to respond to at least a second one of the plurality of feedback requests.

2. The device of claim 1, wherein the device comprises a speaker.

3. The device of claim 1, wherein the device comprises a headset comprising a speaker.

4. The device of claim 1, wherein the first service interval comprises 1 millisecond (ms) and the new service interval comprises 8 ms.

5. The device of claim 1, wherein the first service interval comprises 8 milliseconds (ms) and the new service interval comprises 1 ms.

6. The device of claim 1, wherein the device controller configured to use the new service interval comprises a control system configured to toggle between different ones of a defined set of possible service intervals.

7. The device of claim 1, wherein the device controller is configured to sweep between the first service interval and the new service interval with incremental steps of intermediate service intervals.

8. The device of claim 1, wherein the device controller is configured to select the new service interval based on times between receipts of different feedback requests.

9. The device of claim 8, wherein the device controller is configured to calculate difference between a current feedback request and a previous feedback request.

10. The device of claim 1, wherein the device controller is further configured to provide feedback requests to the USB host.

11. A device comprising an audio device comprising:
a Universal Serial Bus (USB) interface configured to be coupled to a USB-compatible cable; and
a device controller comprising memory containing software configured to:
receive a first feedback request from a USB host over the USB-compatible cable;
provide a feedback response based on a first service interval;
determine that the feedback response missed the first feedback request; and
switch to a second predefined service interval.

12. The device of claim 11, wherein the device controller is configured to test a plurality of predefined service intervals until a feedback response transfer is completed.

13. The device of claim 11, wherein the first service interval comprises a value between 125 microseconds to 1 millisecond (ms) and the second predefined service interval comprises a value greater than or equal to 8 ms.

14. The device of claim 11, wherein the first service interval comprises a value greater than or equal to 8 milliseconds (ms) and the second predefined service interval comprises a value between 125 microseconds and 1 ms.

15. The device of claim 11, wherein the device comprises a speaker.

16. The device of claim 11, wherein the device comprises a headset comprising a speaker.

17. A method for finding a proper service interval for a Universal Serial Bus (USB)-compatible audio device, comprising:
receiving a first feedback request from a USB host;
determining that a first feedback response transfer was missed;
receiving a second feedback request from the USB host; and
using a new service interval.

18. The method of claim 17, further comprising advertising a first service interval.

19. The method of claim 17, further comprising providing a first feedback response to the first feedback request.

20. The method of claim 17, wherein using the new service interval comprises toggling between different ones of a defined set of possible service intervals.

21. The method of claim 20, wherein the defined set is two different service intervals.

22. The method of claim 17, wherein using the new service interval comprises sweeping between a first service interval and the new service interval with incremental steps of intermediate service intervals.

23. The method of claim 17, wherein using the new service interval comprises evaluating times between receipts of different feedback requests.

24. The method of claim 23, wherein evaluating the times comprises calculating a difference between a current feedback request and a previous feedback request.

25. The method of claim 17, wherein receiving the first feedback request from the USB host comprises receiving the first feedback request at a device comprising a speaker.

26. The method of claim 17, wherein receiving the first feedback request from the USB host comprises receiving the first feedback request at a device comprising a headset comprising a speaker.
